(19) United States
(12) Patent Application Publication
(10) Pub. No.: US 2016/0135484 A1
(43) Pub. Date: May 19, 2016

(54) WEIGHT CONTROL METHOD, APPARATUS SYSTEM

(71) Applicant: MARS, INCORPORATED, McLean, VA (US)

(72) Inventor: Claude Ecochard, Aimargues (FR)

(73) Assignee: Mars, Incorporated, McLean, VA (US)

(21) Appl. No.: 14/896,308

(22) PCT Filed: Jun. 5, 2014
(86) PCT No.: PCT/EP2014/061745

§ 371 Date: Dec. 4, 2015

(30) Foreign Application Priority Data
Jun. 5, 2013 (EP) 13305758.8

(51) Int. Cl. A23K 1/10; A01K 5/02; G06F 3/0484; B65B 61/20; A23N 17/00; G06Q 50/22

(52) U.S. Cl. CPC A23K 1/1853; A23K 1/001; B65B 61/20; A01K 5/0275; A23N 17/00; G06F 3/04847

(57) ABSTRACT

The present invention relates to a method of weight control of an individual pet dog or cat, as well as a system and apparatus for weight control of an individual pet dog or cat.

The present invention relates to a method of weight control of an individual pet dog or cat, as well as a system and apparatus for weight control of an individual pet dog or cat.

### BACKGROUND OF THE INVENTION

Maintaining the health and longevity of animals, including pet animals, is a constant need. Pet animals are almost exclusively fed by their owners. Pet owners generally want to provide the best nutrition for their pets, but may be constrained by a limited budget or knowledge regarding dietary needs best suited for their pets.

In particular, pet owners tend to overfeed their pet. Pets are often spoiled by an overabundance of food and high calorie treats, in the mistaken belief that extra food means extra love. This ultimately results in unhealthy and overweight pets. Furthermore, these pets may not be receiving food that is particularly suited for their conditions. In other words, despite the best intentions of pet owners, their pets are not necessarily receiving the most appropriate diet or the most appropriate dietary intake for their pet animals.

An example of overfeeding may be that the present owner has a preferred feeding schedule that is not well suited for the typical container sizes of pet foods offered today. An owner may like to feed a cat five or more times per day to coincide with the times when the owner themselves eats and overfeeding easily occurs.

Many pet owners are uncertain as to the quantity of food to feed their pet animals. Further, different pets and different types of pets may have different dietary needs, which may be beyond the knowledge of the pet owner. Pet animals may differ in their energy requirements, yet the pet owner may be inclined to feed the animals the same amount and types of food during the day, for convenience. A method for feeding the appropriate dietary intake for an individual pet dog or cat is not straightforward nor available to the pet owner.

Accordingly, there is a continuing need for methods, systems and apparatus for weight control of the individual pet dog and pet cat.

### THE INVENTION

The present invention meets that need for an individual pet dog or cat.

Accordingly, a first aspect of the present invention provides a method for weight control of an individual pet dog or cat, the method comprising,
a) defining the energy need of the pet, based on details of the pet,
b) selecting a diet, in the form of one or more foodstuffs, optionally including designing a diet or part of a diet,
c) utilising the defined energy need to determine the quantity of the selected diet to be fed to the pet on a daily basis,
d) providing the one or more foodstuffs of the diet, wherein
   i) the one or more foodstuffs of the diet is in a format containing a quantity of food for one day for the pet according to the defined energy need of the pet,
   ii) the one or more foodstuffs of diet in i) is produced in a number from 21, and
   iii) the one or more foodstuffs include a dry pet food,
e) feeding the pet the one or more foodstuffs of the diet in i) per day for at least 21 days, and
f) before consumption of the provided one or more foodstuffs in step ii), re-defining the energy need of the pet according to step a) above, and
g) repeating steps b) to f) at least twice.

Weight control of a pet dog or cat is essential. The weight control needs to be for an individual animal in order to be effective. Effective weight control cannot be carried out on a group of pet dogs or cats, since each animal is individual and has a different energy need.

Weight control according to the present invention includes weight gain, weight loss, or weight maintenance. The weight control according to the present invention includes both therapeutic and non-therapeutic weight control. Non-therapeutic weight control is included. Therapeutic weight control includes weight loss, in particular for obese and/or diabetic pet does and cats.

The method of the invention includes defining the energy need of the pet, based on details of the pet. Defining the energy need of the pet will determine the quantity of a diet to be fed to the pet. The details of the pet on which to define the energy or need of the pet include age, weight, breed, information, gender, size, activity level, weight related health issues, body fat content, sexual status and/or breeding status. For example an algorithm may be used to determine the energy need of the pet based on the details of the pet such as the Wildsterne Food Algorithm.

Some of the details of the pet, as discussed above, can be determined accurately, such as weight or gender, whereas some of the details may need to be estimated and included as either a range (for example the age of the pet, if not accurately known) or the breed information.

The breed type of the pet may be known due to precise breeding background of the pet or an estimation of a pet breed can also be made by examining the physical attributes of the pet. An estimate of the dogs breed may include determining by examination amongst others, the colour, size, muzzle shape, ear shape, body shape and tail shape of the cat or dog. A large proportion of pets are obtained without knowledge of the pet's parentage, or whether these pets are pure breed or of mixed breed. Therefore, it may be difficult to determine the bred types through a simple examination of the physical attributes alone. Alternatively, or in addition, the breed contributing to the mixed breed pet background can be determined, for example using a DNA-based mixed breed test, for example the Wisdom Panel™ Mixed Breed analysis test, a non-invasive test, as described in U.S. Patent Publication Nos. 2006/0147962, 2006/0008815 and 2006/0235625, all of which are incorporated by reference herein. Other DNA based mixed breed tests for pets may also be used.

It is well known that different types of pets have different nutritional and energy requirements and this will contribute to determining the energy need of the individual pet. The breed information may include determining a major or dominant breed of the pet and optionally one or more subordinate or minor breed of the pet.

Weight related health issues include factors such as recovery from disease, recent or current treatment such as chemotherapy or other therapy, damage from bone disease/breakages, skin damage etc.

The sexual status of a pet dog or a cat will influence the energy need of the pet, for example, if the animal is preparing to be breed or is neutered. The breeding status of the animal will also be relevant, in particular pregnant females and lactating females.

The energy needs of the pet can be defined according to standard systems such as the Body Condition Score and weight management modules as described in the figures.

The energy need of the pet can be determined by the pet owner or somebody else who has details of the pet, for example a pet professional. Preferably, the person defining the energy need of the pet is a vet, a veterinary nurse or a veterinary nutritionist. When the energy need of the pet has been defined, based on details of the pet, a diet can be selected, in the form of one or more foodstuffs. Optionally, selecting the diet includes designing a diet or part of a diet. Accordingly, the diet selected can be a known diet or can be a new diet.

The defined energy need of the pet is utilized to determine the quantity of the selected diet to be fed to the pet on a daily basis.

The purpose of the invention is to provide a “unit” of foodstuffs (also referred to here as one or more foodstuffs in a format containing a quantity of food) which is the appropriate energy content per day (or 24 hours) for the pet animal. The invention relates to a method whereby once the energy needs of the pet are calculated, the one or more foodstuffs is provided to the feeder of the animal, such that the pet owner can provide a unit of foodstuff to the animal per 24 hours. Accordingly, the exact energy needs of the pet are provided. In this way, the weight of the animal will be controlled, either to increase weight, maintain weight or lose weight.

The one or more foodstuffs of the diet is produced in a number from 21 upwards. The number may be from 21 to around 88 (or 89, 90, 91, 92, 93) [representing around 3 months food at one “unit” per day], or from 21 to around 58 (or 59, 60, 61, 62) [representing around 2 months food at one “unit” per day] or from 21 to around 28, 29, 30, or 31 [representing around 1 months food at one “unit” per day].

Thus, the unit of foodstuff is the one or more foodstuffs of the diet in a format containing a quantity of food for one day for the pet according to the defined energy need of the pet. The type of foodstuff in the unit of foodstuff may be the same for each day or may be a different type of foodstuff. Preferably, it is the same type of foodstuff in each batch of from 21 units as set out in the claims. This is because each of these units will contain the identical energy content and amount of foodstuff. The type of foodstuff in any one unit may vary within the number of from 21. The type of foodstuff may be the same within a batch of from 21 in number and may vary between batches or may be the same as a previous or later batch for the same animal. In the above paragraph, the reference to the batch of from 21 also applies to a number in the batch of from 21 to around 88, 89, 90, 91, 92, 93, or from 21 to around 58, 59, 60, 61, 62 or from 21 to around 28, 29, 30, 31.

The one or more foodstuffs includes a dry pet food. The remaining pet food can be provided by a semi-moist food or a wet food. The pet owner will see from the foodstuff provided which combination of foods should be fed to the pet animal on a daily basis (to provide the precise energy needs of the pet). This may comprise one or more types of foodstuff. Preferably, the foodstuff is a single foodstuff and is a dry food, in the form of a kibble.

According to the present invention, the pet owner will not adjust the quantity of food and will provide the one or more foodstuffs (the unit of food) per day which has been calculated according to the energy needs of the pet.

In this way, the pet owner does not adjust the quantity of food and there is no opportunity to over or under-feed the pet animal. The daily packs containing the precise required energy avoid any overfeeding which tends to an overweight pet.

Daily rationing is hard to manage for dry diet especially as it requires weighing the diet. Even rationing is an estimate of the quantity. The volumetric measurement is most often used via cups which are not fully accurate.

A further benefit of the present invention is that the unit provision of the food is presented in one or more complete packages, all of which should be fed to the food during the one day period. The one or more foodstuffs according to the unit provided do not need to be in individual single serving portions. However, the foodstuff in the unit format should be provided to the animal for one day's foodstuff. In this way, there is certainty regarding the amount of food to feed the pet. Furthermore, provision of the food in a unit to be served per day allows a pet owner to feed freshly opened food to the pet every day without having to worry about spoilage or refrigeration of any left over.

The one or more foodstuffs (the unit foodstuff) is provided in a number of from 21, or from 21 to around 88, 89, 90, 91, 92, 93 or from 21 to around 58, 59, 60, 61, 62 or from 21 to around 28, 29, 30, 31 (which can also be referred to as a “batch”). Thus, the pet food owner is ultimately provided with an amount of food to feed to the dog or cat for between 21 up to 88, 89, 90, 91, 92, 93 days or for between 21 up to 58, 59, 60, 61, 62 days or from 21 up to 28, 29, 30, 31 days.

In accordance with the method of the first aspects of the invention, the pet is fed the one or more foodstuffs (the unit format of the diet) for at least 21 days (and between 21 and up to 88, 89, 90, 91, 92, 93, 58, 59, 60, 61, 62 or 28, 29, 30, 31 days). Before the end of the specified days and thus before complete consumption of the provided one or more foodstuffs according to the invention, the energy need of the pet is re-defined based on details of the pet. Preferably, the re-defining the energy is based on the same details of the pet, although they need not be identical. At least 2, 3, 4, 5, 6, 7, 8, 9, 10, 11, 12 or more details of the pet should be the same details as the initial defining the energy need of the pet (and preferably calculated in the same manner).

When the energy need of the pet has been re-defined, the steps of the method are repeated at least twice. Thus, three rounds of defining the energy need of the pet, selecting the diet, providing the diet and feeding the diet for 21 days or more is conducted.

In this way, the animal has a feeding cycle of from 21 days upwards, including up to around 3 months (88, 89, 90, 91, 92, 93 days) or 2 months (58, 59, 60, 61, 62 days) or 1 month (28, 29, 30, 31 days) and between each feeding cycle has its defined energy needs re-calculated according to the invention. A typical feeding cycle is 1, 2 or 3 months (approx. 4, 8 or 12 weeks).

Preferably, the method of the invention is carried out when determining the energy need of the pet is carried out by the user on a user interface including a data entry system, the user interface being coupled to a computer. The details of the pet to determine the energy need per day are added to the user interface. This may be in response to questions posed to the user on the interface.

The answers are analysed according to a computer program as part of the computer. An analysis, optionally including an algorithm designed to calculate the energy need of the pet is carried out and the results presented to either the user to an alternative receiver. Such an alternative receiver or the user, will understand the results and be able to, optionally with assistance, select a diet, in the form of one or more foodstuffs, optionally designing the diet or part of the diet in accordance with the invention.

The interface presented to the user (usually presented in the form of a monitor) may present the questions regarding the detail of the pet as a computerised assessment survey. This may be in the form of an interactive program stored locally in a memory unit of a computing system and executed by a microprocessor of a computing system. Accordingly the program may be locally installed in a computer used by the pet professional without requiring that the computer be in communication with a server. This allows the veterinary professional or indeed the pet user to perform the input regarding the pet details using a tablet/ipad/laptop in a mobile situation.

The information may be stored in the computer, either locally or at a central server.

Alternatively, the input can be performed manually using a pen and paper or any other kind of recording of the pet details.

The present invention includes the provision according to the first aspect of the invention, of a standard known diet (for example a diet “off the shelf”) if that is possible or a newly designed diet specific for the needs of the pet. In addition, whichever diet is contemplated, the correct amount of food, in order to accurately provide a diet to meet the required energy for the dog or cat in question, is required.

The diet of any aspect of the invention can be any dog or cat foodstuff, such as dry, semi moist or wet food product.

The pet foodstuff is preferably a commercial pet food product. Such a product is preferably sold as a product for feeding to a pet animal, in particular a pet cat or a pet dog.

A typical pet foodstuff contains about 20-30% crude protein and about 10-20% fat, the remainder being carbohydrate, including dietary fibre and ash. A typical wet or moist product contains (on a dry matter basis) about 40% fat, 50% protein and the remainder being fibre and ash. The foodstuff of the invention may be a dry product (with approximately 5 to approximately 15% moisture), a semi-moist product (with approximately 15 to approximately 70% moisture) or a wet product (with approximately 70 to approximately 90% moisture). Preferably the food is a dry product in the form of a kibble.

The remaining components of the foodstuff are not essential to the invention and typical standard products can be included. The combined ingredients of the foodstuff according to the invention can provide all of the recommended vitamins and minerals for the particular animal in question (a complete and balanced food).

The foodstuff according to the present invention encompasses any product which a pet consumes in its diet. Thus, the invention covers standard food products including liquids, as well as pet food snacks (for example, snack bars, pet chew, crunchy treat, cereal bars, snacks, biscuits and sweet products) and supplements.

The foodstuff can be provided as a food supplement. The food supplement can be a powder, sauce, topping, biscuit, kibble, pocket or tablet that can be administered with or without an additional foodstuff. Where the food supplement is administered with an additional foodstuff, the food supplement can be administered sequentially simultaneously or separately. The food supplement may be mixed with the foodstuff, sprinkled over the foodstuff or served separately. Alternatively, the food supplement can be added to a liquid provided for drinking such as water or milk.

The foodstuff is preferably a cooked product. It may incorporate meat or animal derived material (such as beef, chicken, turkey, lamb, fish, blood plasma, marrow bone etc. or one or more thereof). The product alternatively may be meat free (preferably including a meat substitute such as soya, maize gluten or a soya product) in order to provide a protein source. The foodstuff may contain additional protein sources such as soya protein concentrate, milk proteins, gluten etc. The foodstuff may also contain a starch source such as one or more grains (e.g. wheat, corn, rice, oats, barley etc.), or may be starch free.

The foodstuff of the invention is preferably produced as a dry product containing from approximately 5% to approximately 15% moisture. The preferred dry food is more preferably presented as a small biscuit-like kibbles.

Any diet can be included as part of the invention. The diet may include one or more ingredient as needed. Where weight loss is needed, the diet may be a diet which supports satiety, such as the Royal Canin Satiety management veterinarian support weight diet.

A second aspect of the invention relates to a system for weight control of an individual pet cat or dog, the system comprising,
xi) a computer,
xii) a user interface including a data entry system, said user interface coupled to said computer and configured to receive information regarding a defined energy need of an individual pet cat or dog and to transmit the information to food manufacturing apparatus to manufacture,
xiii) one or more foodstuffs in a format containing a quantity of food for one day for the pet according to the defined energy need information received, wherein
xiv) the one or more foodstuffs of iv) is provided in a number from 21 and
xv) the one or more foodstuffs includes a dry pet food.

All aspects of the first invention also apply to the second.

The user interface coupled to the computer is preferably configured to prompt a user at the user interface to enter the information to determine the defined energy need of the pet (ie a data entry system). The computer is configured to process the information received in order to define the energy need of the pet, according to the received information.

The computer is further configured to generate at least one control signal to control the food manufacturing apparatus, as required. The system may also include food manufacturing apparatus.

The system may include apparatus (according to the third aspect of the invention and discussed below).

A third aspect of the invention provides apparatus for providing a diet for weight control of an individual pet dog or cat, the apparatus comprising,
xxi) means for receiving information of the defined energy need of the pet for one day,
xxii) means for providing one or more foodstuffs of a diet in a format containing a quantity of food for one day for the pet according to the defined energy need in xxi), wherein
xxiii) the one or more foodstuffs in xxi) is provided in a number from 21 and the one or more foodstuffs includes a dry diet,
xxiv) means to repeat steps xxi) to xxiii) at least twice.

All preferred features of the first and second aspects of the invention, also apply to the third.

The method, system and apparatus of the invention can be described as follows:

An apparatus according of the third aspect of the invention (and optionally part of the first and second aspects) includes an electronic user interface and a main operating computer which is electronically coupled to the user interface. The apparatus also includes a manufacturing and packing apparatus electronically coupled to the main computer. As described above, the user interface may be local to the main computer or remote. The user interface includes means for receiving the information such as a desktop computer, keyboard, touchscreen, voice activated digital system etc. The user interface is coupled to the main computer through standard means such as cables or phone line or wireless means. The main computer receives the information from the user interface and determines, according to appropriate means such as an algorithm or programme, the energy needs of the pet animal for a day (or 24 hour period). The main computer is set up to be able to generate a control signal for controlling a pet food manufacturing apparatus.

In one option, the main computer generates the control system through a programmable logic controller (as known and commonplace in the art). The food manufacturing apparatus is any apparatus, including standard apparatus as known in the art.

The energy needs of the pet, as determined, may be stored in a database and linked to or part of the main computer. The main computer can access the database in order to general the signal for the control signal. The control signal sent from the computer to the apparatus to manufacture the food is effectively a set of manufacturing instructions for food manufacture. Together with any additional input, either manual or electronic, the manufacturing instructions direct the manufacture of the foodstuff.

The requirements of the invention are that the foodstuff is created such that:
There is provision of one or more foodstuffs of the diet, wherein
   i) the one or more foodstuffs of the diet is in a format containing a quantity of food for one day for the pet according to the defined energy need of the pet,
   ii) the one or more foodstuffs of diet in i) is provided in a number from 21 and
   iii) the one or more foodstuffs include a dry pet food,

Accordingly, the manufacturing apparatus will enable to provision of such optionally different foodstuffs and in the appropriate package numbers. Manual assistance may be needed and can be provided.

Typical food manufacturing apparatus can be used for the present invention such as those described in Small Animal Clinical Nutrition, 4^{th} Edition, Hand Thatcher Remillard Roudebush, 2000 and The Technology of Extrusion Cooking, Blackie Academic & Professional, 1994, Chapman & Hall.

In addition to the basic foodstuffs, the foodstuff can be manufactured to include the usual flavours, additives, vitamins and minerals, fats, soluble and insoluble fibres, preservatives, palatable coatings etc. Preferably a compete and balanced food is provided for each foodstuff.

The main computer can also send instructions for labelling and packaging of the product, such as including the pet name on the food and/or numbering the packages to be fed from 1 to 21 (to be fed on day 1 to 21, respectively), onward.

The fourth aspect of the invention relates to method for manufacturing packages of foodstuff for a pet, comprising:
i. receiving details of the pet;
ii. determining an energy need for the pet based on the received details;
iii. providing at least 21 units of foodstuff, wherein the quantity of foodstuff in each unit is dependent on the defined energy need for the pet and each unit of foodstuff is provided in one or more packages; and
iv. repeating steps i. to iii. at least twice.

A fourth aspect of the invention also relates to a method for manufacturing packages of foodstuff for a pet using an apparatus, the apparatus comprising:
a receiving module for receiving and storing pet data on details of the pet;
a determining module, upon receiving the pet data, for determining energy data on an energy need for the pet based on the pet data; and
a production data creating module, upon receiving the energy data, for creating foodstuff data on at least 21 units of foodstuff, wherein the quantity of foodstuff in each unit is dependent on the defined energy need for the pet and each unit of foodstuff is provided in one or more packages;
an input device for receiving user-inputted instructions or data; and
a memory device, linked to all or part of the receiving module, the determining module and the production data creating module, for storing the pet data, the energy data and the foodstuff data.

A fifth aspect of the invention also relates to an apparatus for packaging a foodstuff for a pet, comprising:
a data processor for receiving a foodstuff data from a calculation unit linked thereto, and processing and converting the data into ingredient data;
a foodstuff dispenser for dispensing foodstuffs as indicated by the ingredient data, the foodstuff dispenser includes a plurality of compartments each containing one kind of foodstuff;
a container for receiving at least one foodstuffs from the foodstuff dispenser; and a packer for sealing and packing the bag.

All features of the first to third aspects of the invention also apply to the fourth and fifth aspects. In particular, this relates to the energy needs of the pet as described herein, the purpose of the invention as described herein, the one or more foodstuffs of the diet as described herein and details regarding the unit of the foodstuffs. The manner of the pet owner is also as described herein as is the daily rationing and unit provision of the food as described herein. Details with regard to the number of units is as described above and details regarding the user, the user interface, the data entry system and the computer programme as part of the computer. The particular benefits of the present invention relate to determining the energy needs for the pet based on the received details and providing at least 21 units of foodstuff, wherein the quantity of foodstuff in each unit is dependent on the defined energy need for the pet and each unit of foodstuff is provided in one or more packages with the repetition step as set out according to the aspects of the invention. The apparatus is commonplace and standards in the art, typically including technology to provide wet and/or dry pet food including mixers, extruders under heat and/or pressure and/or shaping. The extruder may produce a continuous strand or cut product or may produce a wet food to be sterilised under a canning procedure.

The invention is described with reference to the following non-limiting examples:

### EXAMPLES

### Example 1

A questionnaire is set out on a user interface at a veterinary location. The questionnaire is completed by the veterinarian for the pet dog called Gizmo with the following information:
Name of pet: GIZMO
Breed of pet: Labrador Retriever
Weight: 38 kg
Age: 3 years
Gender: male
Spayed/Neutered: Yes
Activity Level: Moderate
Food Preferences: None

These details provided on the user interface were submitted and using a typical calculation carried out on a computer, the results determined that the energy need of the pet is 942 kcal per day (for an ideal weight for this dog of 32 kg), which is 63% of the normal energy allocation to start weight loss.

A standard dry kibble diet, namely Royal Canin Obesity Canine dry was selected. It was determined that 302 g/per day is the amount of the diet need to meet the defined energy need of Gizmo.

A box was provided containing 30 packages of the standard dry kibble, each containing 302 g.

The box of 30 packages was couriered to the home of Gizmo (and Gizmo's owner).

In accordance with the one daily feeding regime preferred by Gizmo's owner, Gizmo is fed one package of the diet, with unlimited fresh water, daily. A single package only needed to be opened per day. There is no decision making for Gizmo's owner regarding the feeding of extra food to Gizmo.

After 28 days, Gizmo's weight is taken and his weight, together with the other details previously submitted on the user interface were re-submitted.

On re-calculation of the energy need of Gizmo, using the same calculation as previously used, it was determined that Gizmo's energy requirement was now 918 kcal.

As previously carried out, using a similar diet, namely Royal Canin Obesity Canine dry, it was determined that 294 g/per day was the amount of the diet needed to meet the newly calculated energy requirement of Gizmo.

Again, a box was provided containing, this time, 32 packages of the diet (since Gizmo and his owners were on vacation in 29-31 days from the calculated start of feeding on the new diet). The package arrived 33 days after the feeding regime above was stated. Gizmo was fed one package per day of the diet, for 28 days, at which time the details were again re-submitted, including Gizmo's new weight (of 34 kg).

The above cycle was repeated for Gizmo, such that Gizmo was fed a single package of food according to the method of the invention for a total of (33+31+35) 99 days. At the end of the 99 days, Gizmo had lost 13 lb weight.

Gizmo's owner at this time was so pleased with the weight loss of Gizmo he continued with further cycles of the invention but no further details were retained.

### Example 2

A questionnaire is set out on a user interface a supermarket. The questionnaire is completed by the owner of a pet cat called Sonny with the following information:
Name of pet: Sonny
Breed of pet: American Shorthair
Weight: 15.4 lbs.
Age: 6 years
Gender: Male
Spayed/Neutered: Yes
Activity Level: Low
Body Condition scoring: 7 (on a scale of 9)
Food Preferences: Tuna

These details were inputted on the user interface and were submitted. Using a calculation carried out on a computer, the results determined that the energy need of the cat is 147 kcal per day.

A combination of two diets was selected for daily feeding. The two diets were a wet diet of Obesity Management Feline and a dry diet of Satiety Support Feline provided in the following amounts:
Wet diet: 1 pouch of 100 g
Dry diet: 31 g
   in the amount of the diet needed to meet the defined energy need of Sonny.

A box was provided containing 33 packages of the diet in a format containing 33 packages of food, each for one day of the cat.

The box was couriered to the home of Sonny (and Sonny's owner).

In accordance with the twice daily feed regime preferred by Sonny's owner, Sonny is fed the wet diet in the morning and dry diet in the evening, each once per day, with unlimited fresh water. A single package for each feed once in the morning and once in the evening meant no packages need to be retained during the day in an unopened state. There is no decision making for Sonny's owner regarding the feeding of extra food to Sonny.

After 30 days, Sonny's weight is taken again and together with the other details previously submitted on the user interface submitted. In addition, the details of the cat included at this time but a food preference included variety of tastes.

On recalculation of the energy need of Sonny, using the same calculation as previously used, it was determined that Sonny's energy requirement was now 149 kcal.

As previously carried out, a box of 33 formats of food are provided to Sonny's owner, for feeding daily. In this case, the wet food provided included a variety of protein sources, including tuna, and rabbit.

The above cycle was repeated for Sonny, such that Sonny was fed a daily diet calculated to exactly meet Sonny's energy requirements on a daily basis. At the end of a total of 100 days, Sonny had 2.5 lost pounds in weight.

1. A method for weight control of an individual pet dog or cat, the method comprising,
a) defining the energy need of the pet, based on details of the pet,
b) selecting a diet, in the form of one or more foodstuffs, optionally including designing a diet or part of a diet,
c) utilizing the defined energy need to determine the quantity of the selected diet to be fed to the pet on a daily basis,
d) providing the one or more foodstuffs in one or more units, wherein
i) each unit contains a quantity of food for one day for the pet according to the defined energy need of the pet,
ii) at least 21 units are provided, and
iii) the one or more foodstuffs include a dry pet food,
e) feeding the pet one unit per day for at least 21 days, and
f) before consumption of the at least 21 units, re-defining the energy need of the pet above, and
g) repeating steps b) to f) at least twice.

2. The method as claimed in claim 1 wherein defining the energy need of the pet is carried out by a user on a user interface including a data entry system, the user interface being coupled to a computer.

3. The method as claimed in claim 2, wherein the user is a pet professional.

4. The method, as claimed in claim 1, wherein the details of the pet on which to define the energy need of the pet include age, weight, breed information, gender, size, activity level, weight-related health issues, sexual status, body-fat content and/or breeding status.

5. The method, as claimed in claim 1, wherein the one or more foodstuffs is a dry food only or a combination of dry food and wet food or a combination of dry food and wet food and another food.

6. The method, as claimed in claim 1, wherein the food preferences of the pet are included in selecting a diet or part of the diet.

7. The method as claimed in claim 1, wherein the one or more units are provided in a single package.

8. The method, as claimed in claim 1, wherein the weight control is weight gain, weight loss or weight maintenance.

9. The method as claimed in claim 1, wherein selecting the diet includes taking into account any disease and/or disorder of the pet, including a genetic predisposition to any disease and/or disorder.

10. The method as claimed in claim 9, wherein taking into account any disease and/or disorder of the pet is carried out by inputting details of the disease and/or disorder on a user interface including a data entry system, the interface being coupled to a computer.

11. The method, as claimed in claim 1, wherein re-defining the energy need of the pet and repeating steps b) to e) is carried out at least three, at least four, at least five, at least six, at least seven, at least eight, at least nine, or at least ten times.

12. A system for weight control of an individual pet cat or dog, the system comprising,
a) a computer,
b) a user interface including a data entry system, said user interface coupled to said computer and configured to receive information regarding a defined energy need of an individual pet cat or dog to transmit the information to food manufacturing apparatus to manufacture,
c) one or more foodstuffs provided in a unit containing a quantity of food for one day for the pet according to the defined energy need information received, wherein
at least 21 units are provided and
the one or more foodstuffs include a dry pet food.

13. The system as claimed in claim 12 wherein the one or more units are provided to the pet cat or dog for feeding.

14. Apparatus for providing a diet for weight control of an individual pet dog or cat, the apparatus comprising,
a) means for receiving information of the defined energy need of the pet for one day,
b) means for providing one or more foodstuffs of a diet in a unit containing a quantity of food for one day for the pet according to the defined energy need wherein at least 21 units are provided and the one or more foodstuffs includes a dry diet,
c) means to allow for the repetition of receiving information and providing one or more foodstuffs at least twice.

15. The apparatus as claimed in claim 14, wherein the means to receive information of the defined energy need of the pet comprises a computer configured to process the individual pet information.

16. A method for manufacturing packages of foodstuff for a pet, comprising:
i. receiving details of the pet;
ii. determining an energy need for the pet based on the received details;
iii. providing at least 21 units of foodstuff, wherein the quantity of foodstuff in each unit is dependent on the defined energy need for the pet iv. labeling and packaging each unit of foodstuff in one or more packages wherein the label on each one or more packages includes sequential numbering of the at least 21 units of foodstuff; and
v. repeating steps i. to iv. at least twice.
